(19) United States
(12) Patent Application Publication
(10) Pub. No.: US 2011/0119284 A1
(43) Pub. Date: May 19, 2011

(54) GENERATION OF A REPRESENTATIVE DATA STRING

(76) Inventors: Krishnamurthy Viswanathan, Sunnyvale, CA (US); Ram Swaminathan, Cupertino, CA (US)

(21) Appl. No.: 12/812,919

(22) PCT Filed: Jan. 18, 2008
(86) PCT No.: PCT/US08/51516

§ 371 Date: Jul. 14, 2010

(51) Int. Cl. G06F 17/30

(52) U.S. Cl. 707/758; 707/E17.039

(57) ABSTRACT

Provided are, among other things, systems, methods and techniques for generating a representative data string. In one representative implementation: (a) starting data positions are identified within input strings of data values; (b) a subsequence of output data values is determined based on the data values at data positions determined with reference to the starting data positions within the input strings; (c) an identification is made as to which of the input strings have segments that match the subsequence of output data values, based on a matching criterion; (d) steps (a)-(c) are repeated for a number of iterations; and (e) the subsequences of output data values are combined across the iterations to provide an output data string, with the determination in step (b) for a current iteration being based on the identification in step (c) for a previous iteration.

### FIELD OF THE INVENTION

The present invention pertains to systems, methods and techniques for generating a representative data string from a number of input data strings and can be used, e.g., for collaborative compression of the input data strings.

### BACKGROUND

A variety of different algorithms exist for attempting to reconstruct an original source bit string based on one or more bit strings that have been received across a communication channel. Different ones of these algorithms make different assumptions regarding the characteristics of the communication channel. However, each typically assumes that the communication channel causes certain random bitwise-independent modifications of the original bit string.

Many of such conventional algorithms impose limitations on the kinds of modifications that can be made by the communication channel, such as limiting the possible modifications to bit deletions or limiting the maximum number of modifications that the channel can make. Unfortunately, such limitations are not always realistic.

### SUMMARY OF THE INVENTION

The present invention provides approaches that often can accommodate a wider variety of potential modifications to an original data string, e.g., including changes to data values, insertions of data values and/or deletions of data values.

One embodiment of the invention is directed to generating a representative data string, in which: (a) starting data positions are identified within input strings of data values; (b) a subsequence of output data values is determined based on the data values at data positions determined with reference to the starting data positions within the input strings; (c) an identification is made as to which of the input strings have segments that match the subsequence of output data values, based on a matching criterion; (d) steps (a)-(c) are repeated for a number of iterations; and (e) the subsequences of output data values are combined across the iterations to provide an output data string, with the determination in step (b) for a current iteration being based on the identification in step (c) for a previous iteration.

Another embodiment is directed to generating a representative data string, in which: (a) a pointer is set to a data position within each of a number of input strings of data values; (b) a subset of the input strings is selected; (c) an output data value is generated based on the data values designated by the pointers within the subset of the input strings; (d) the output data value is appended to an output data string; (e) the pointers within the subset of the input strings are incremented; (f) steps (c)-(e) are repeated a number of times so as to generate a new segment of the output data string; and (g) steps (a)-(f) are repeated for a number of iterations, with the pointers being set in a current iteration of step (a) based on an ability to match portions of the input strings to the new segment of the output data string generated in an immediately previous iteration.

The foregoing summary is intended merely to provide a brief description of certain aspects of the invention. A more complete understanding of the invention can be obtained by referring to the claims and the following detailed description of the preferred embodiments in connection with the accompanying figures.

### BRIEF DESCRIPTION OF THE DRAWINGS

In the following disclosure, the invention is described with reference to the attached drawings. However, it should be understood that the drawings merely depict certain representative and/or exemplary embodiments and features of the present invention and are not intended to limit the scope of the invention in any manner. The following is a brief description of each of the attached drawings.

FIG. 1 is a block diagram illustrating the concept of multiple data strings having been derived from a single source data string.

FIG. 2 is a block diagram illustrating a system for compressing and decompressing data strings based on a source data string estimate.

FIG. 3 is a flow diagram illustrating a process for generating a representative data string according to a first embodiment of the present invention.

FIG. 4 illustrates output and input data string data positions, together with typical initial pointer designations for determining the first segment of the output data string.

FIG. 5 illustrates output and input data string data positions, together with exemplary initial pointer designations for determining a subsequent segment of the output data string.

FIG. 6 is a flow diagram illustrating a process for generating a representative data string according to a second embodiment of the present invention.

FIG. 7 illustrates an algorithm for generating a representative data string in accordance with the second embodiment of the present invention.

FIG. 8 is a flow diagram illustrating a process for generating a representative data string according to a third embodiment of the present invention.

### DESCRIPTION OF THE PREFERRED EMBODIMENT(S)

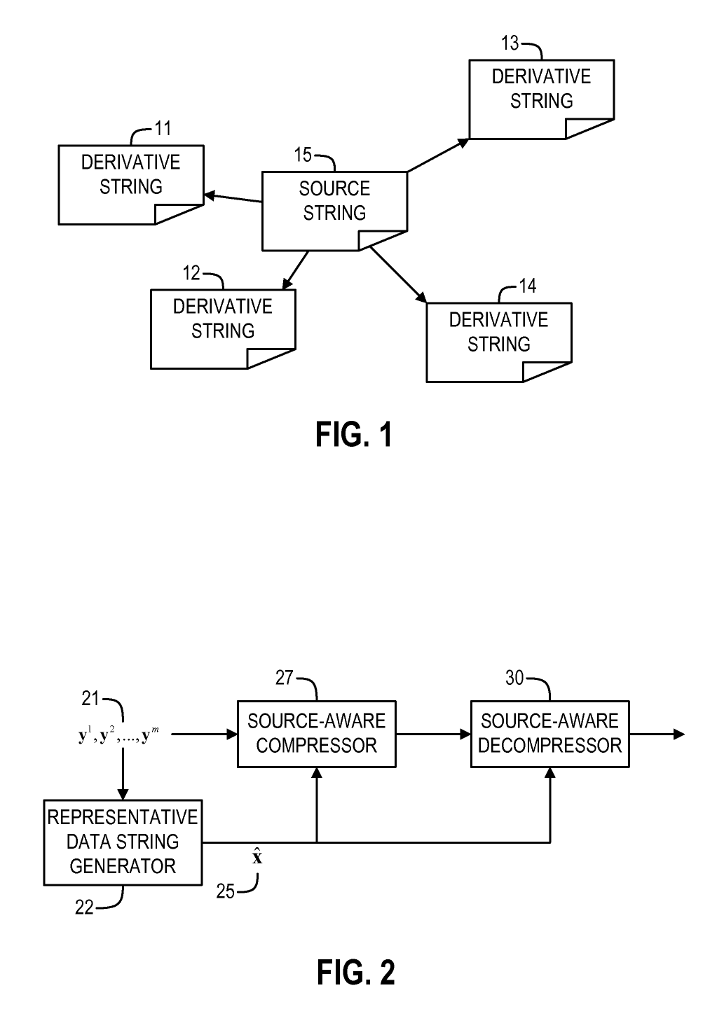

The present invention concerns, among other things, techniques for generating a representative data string from a number of input data strings. In many cases, as shown in FIG. 1, the input data strings 11-14 can be thought of as having been generated as modifications or derivations of some underlying source data string 15. That is, beginning with a source data string 15, each of the individual data strings 11-14 can be constructed by making appropriate modifications to the source data string 15, with such modifications generally being both qualitatively and quantitatively different for the various input data strings 11-14.

In fact, such a conceptualization often is possible even where some or all of the input data strings 11-14 have not been derived from a common source data string 15, provided that the data strings 11-14 are sufficiently similar to each other. For example, such similarity might arise because the data strings 11-14 have been generated in a similar manner to each other. In any event, the individual data strings 11-14 preferably can be generated from the original source data string 15 by modifying data values within source data string 15, deleting data values from source data string 15, and inserting new data values at various positions into source data string 15 (or at least retroactively generated from an estimate of the original source data string 15, in a similar manner). For binary values, data values/position deletions correspond to dropped bits, data value/position insertions correspond to inserted bits, and data value/position modifications correspond to bit flips. In certain embodiments of the invention, these operations are viewed as occurring randomly and independently with respect to each data position within the original source data string 15.

Each of the original source data string 15 and the individual input data strings 11-14 ordinarily will include a sequence of data values at discrete data positions. In the preferred embodiments of the invention, each data position holds a binary data value, i.e., is a single bit. However, in alternate embodiments the data values can be defined across any desired set of potential values, and in certain embodiments different data positions within the same string can even have different sets of potential values.

Ordinarily, the original source data string 15 will not be available. That is, all that will be directly observable are the modified versions, e.g., data strings 11-14. In such cases, it often will be desirable to attempt to reconstruct original source data string 15, to the extent possible. For example, once the original data string 15 has been estimated, that estimate can then be used as a basis for compressing the individual data strings 11-14.

In addition, knowledge of the original source data string 15 can be useful in and of itself. For example, where the observable data strings 11-14 are DNA sequences for samples of a particular species, estimation of the original source data string 15 according to the present invention often can enable one to know what the standard DNA sequence is for that species.

Even where the original source data string 15 (or some estimate of it) is available, the techniques of the present invention often can be advantageously used to generate a representative data string. That is, even in this situation, the representative data string generated according to the present invention often still can provide additional information and/or be useful for compression purposes, e.g., in the manner indicated above. Such might be the case, for example, where the process by which the observable data strings 11-14 were generated is not zero-mean (in at least one respect), but rather has some kind of bias. In these cases, a representative data string can be generated using the techniques of the present invention and then compared to the original source data string 15 in order to study the nature of the process that resulted in the observable data strings 11-14 (e.g., including quantification of any biases). Typically in such cases, because it lacks the bias of the original source data string 15, the representative data string generated according to the present invention also will provide better compression results when used as a basis for differential compression.

The examples described below typically assume an input set of data strings 11-14. However, it should be noted that such references are for ease of explanation only. Any number of input data strings can be used.

FIG. 2 illustrates an example of one context in which the present invention might operate. Here, the goal is to compress a set of input strings y¹, y², . . . , y^{m} 21. For example, each input string 21 might be a different file represented by its bit values, byte values or other standard data units. In fact, it should be noted that any of the generic references herein to “data strings” typically can include (or be replaced with a reference to) a data string that represents a data file or document. However, the term “data string” and similar terms, as used herein, are broader, encompassing any data string, whether or not encapsulated within a unit that ordinarily would be thought of as a “file” or “document”, unless expressly noted otherwise.

As indicated above, the individual strings 21 (e.g., files) could have been derived from a common source string (e.g., file), such as would be the case if the source string was transmitted through a noisy communication channel, if the source string was edited by a number of different individuals to produce corresponding different strings (e.g., files), or if the individual strings 21 were generated similarly without necessarily having been derived from a common source string, such as where each represents a sequence of readings obtained from different (but similar) sensors measuring or recording the same physical phenomenon (e.g., image, audio signal, seismographic data or weather data) and/or where the individual strings 21 were generated subject to the same or similar constraints.

In any event, the set of input strings 21 is input into a representative data string generator 22, according to the present invention, which generates a representative data string \hat{x} 25. Then, both the input strings 21 and the output representative data string 25 are input into source-aware compressor 27, which preferably separately compresses each of the input strings 21 (as well as any additional strings, not shown, which preferably have been identified as having been generated in a similar manner to input strings 21) relative to the representative data string 25, e.g., using any available technique for that purpose (e.g., any conventional technique for differentially compressing one string of data values relative to another, preferably losslessly). The strings 21, as thus compressed, can then be, e.g., stored onto a computer-readable medium and/or transmitted over a communication channel. Later, when any particular string is desired to be retrieved, its compressed version is input into source-aware decompressor 30, together with the representative data string 25, which then performs the corresponding decompression. Such decompression preferably is a straightforward reversal of the compression technique used in module 27.

Additional discussion regarding compression and decompression is provided in commonly assigned U.S. patent application Ser. No. 11/930,982, filed on Oct. 31, 2007, which application is incorporated by reference herein as though set forth herein in full. Although the '982 application discusses generation of a source file estimate using different techniques than are presented here, the compression and decompression approaches discussed therein also can be applied with respect to a representative data string generated according to the present invention, e.g., with modifications to take into account insertions and deletions. Alternatively, any of a variety of other differential compression techniques that take into account insertions and deletions instead can be used.

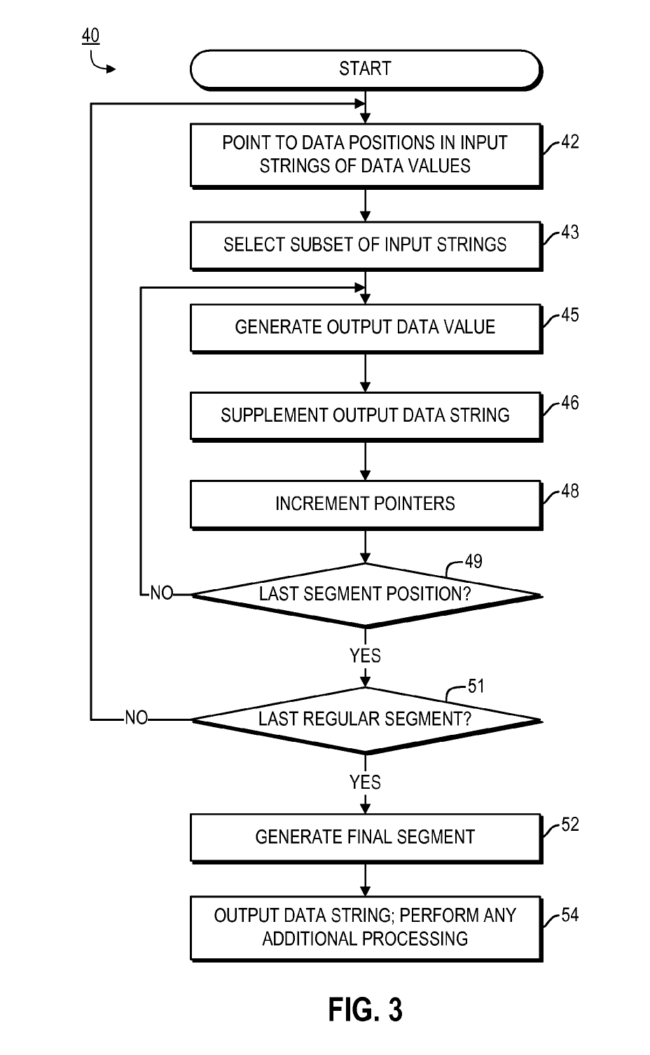

FIG. 3 is a flow diagram illustrating a process 40 for generating a representative data string according to a first embodiment of the present invention. The process 40 assumes the existence of a number of input data strings (e.g., data strings 11-14). Preferably, the steps of the process 40 are performed in a fully automated manner so that the entire process 40 can be performed by executing computer-executable process steps from a computer-readable medium (which can include such process steps divided across multiple computer-readable media), or in any of the other ways described herein.

At the outset, it is noted that the present embodiment typically attempts to generate the representative output data string in a sequence of consecutive segments (sometimes referred to as blocks). Such segments preferably are substantially all of the same length (e.g., other than the last segment which might be shorter than the fixed length that has been selected for the particular implementation). However, in alternate embodiments different lengths are used (e.g., in an adaptive manner in response to changing insertion, deletion and/or modification probabilities). As discussed in more detail below, and as illustrated in FIG. 3, these segments preferably are generated by performing corresponding iterations through certain of the steps of process 40.

Initially, in step 42 a data position is pointed to in certain of the input strings of data values. In the preferred embodiments, this data position is, for a particular input string, the data position that has been determined to correspond to the start of a current data segment to be generated for the output data string. It is noted that a pointer can be designated in this step 42 for each of the available input data strings or only for some of them.

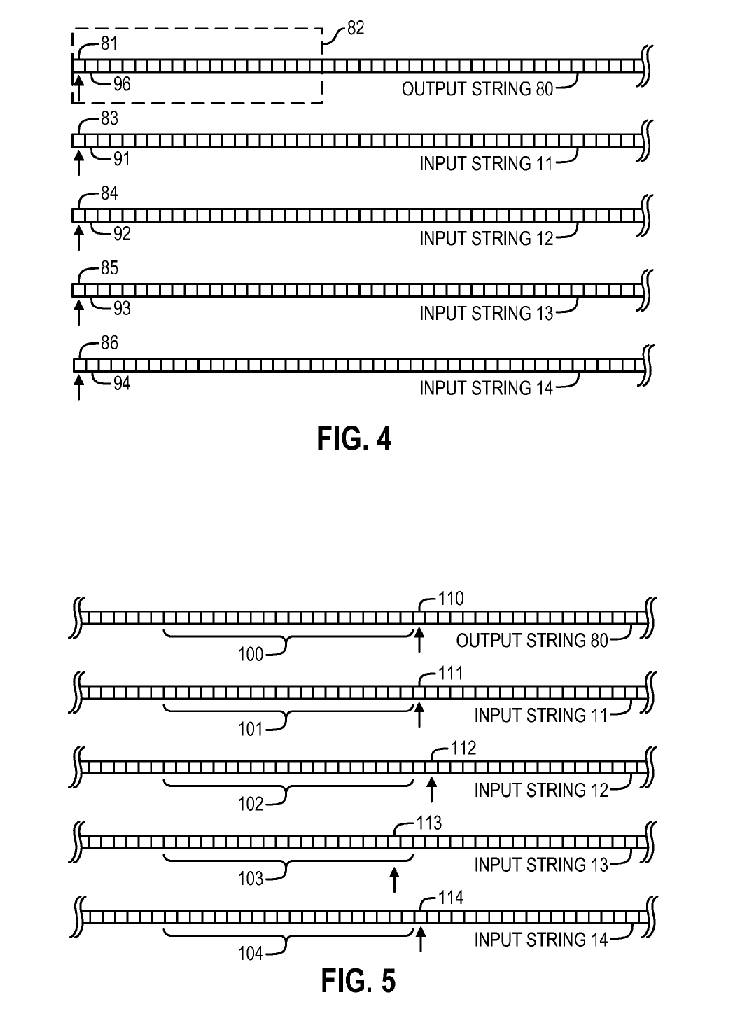

FIG. 4 illustrates a typical pointer arrangement for the first iteration of process 40. When the first iteration of this step 42 is performed, it often will be the case that very little is known about the input data strings 11-14 in relation to the output data string 80 that is to be generated. At the same time, the first position 81 of the current segment 82 for which a data value is to be generated for the output data string 80 preferably is the very first data position within output data string 80. Accordingly, in this situation, it is preferred to simply point to the very first data position 83-86 (e.g., the very first bit) within the subject input data string 11-14, respectively.

In subsequent iterations of this step 42, after a portion of the output data string 80 has been determined, it typically will be possible to make a better judgment about which data position within each input data string corresponds to the start of the current segment. Accordingly, in these situations, it often will be the case that different data positions will be pointed to in different ones of the input data strings. Such a situation is described in more detail below in connection with FIG. 5.

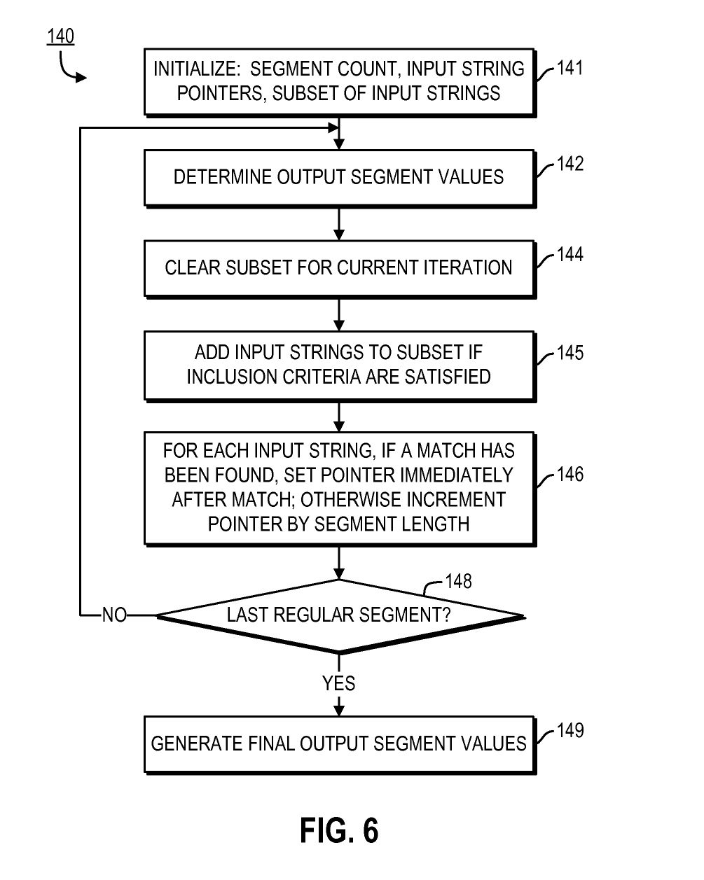

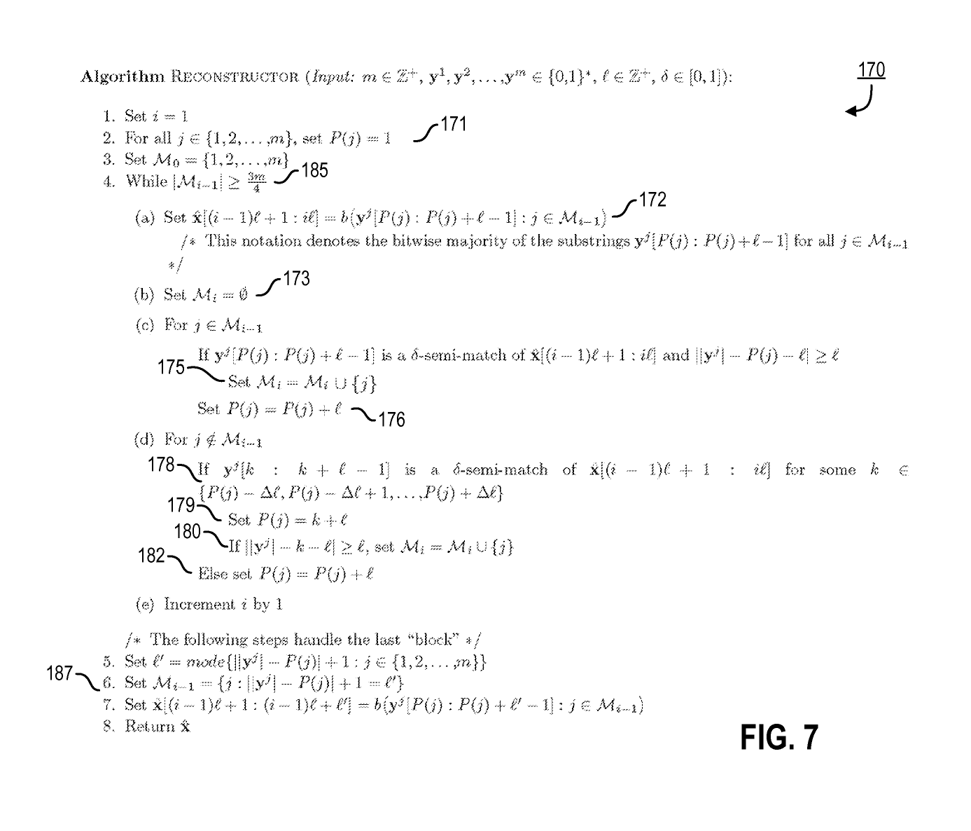

In step 43, a subset of the input data strings is selected. This subset preferably includes only those input data strings for which the pointers designated in step 42 are determined to reliably correspond to the first data position for the current segment of the output data string. Although a variety of different criteria can be used for determining such reliability, the preferred criterion looks at whether a match was identified to the immediately previous segment that was generated for the output data string 80. On the first iteration of this step 43, no such previous segment will have been generated, so all of the input data strings preferably are included within the subset. For the second and subsequent segments, the preferred criterion requires that either the immediately previous segment in the input string matches the corresponding segment that was generated for the output string or that a matching segment can be found within the input string (e.g., using a defined search window or other search criteria). One particular reliability criterion is discussed below in connection with the embodiments represented in FIGS. 6 and 7.

Similarly, the criterion for determining whether a segment in an input string “matches” a corresponding segment in the output string can be defined differently in different embodiments of the invention. In one embodiment, each data position in an input string relative to the starting position (determined in step 242) for the current segment is used to determine the value of the data position having the same offset from the starting second position in the output string, and the “matching” criterion is defined in terms of a distance measure. More preferably, the distance measure is the Hamming distance, i.e., the number of bit positions (or other data positions) in which the two strings differ, and a match is only declared based on a determination of whether the Hamming distance between two segments is less than or equal to a specified maximum threshold (e.g., a constant threshold that is fixed across all input segments and all iterations). However, any other distance measure and/or any other criterion instead can be used.

In step 45, an output data value is generated based on the values within the data positions currently designated by the pointers for the input strings in the subset selected in step 43. For embodiments in which the data positions contain binary values, the output data value preferably is the bitwise majority of such data values. In alternate embodiments, the value is the mean, median, mode, weighted average (e.g., in embodiments where reliability scores have been assigned to the various input strings within the selected subset and the weights are based on such scores), or any other function of such data values.

In step 46, the output string is supplemented with the output data value generated in step 45. Preferably, this step involves simply appending the new data value to the existing output string 80.

In step 48, the pointers for the various input strings within the selected subset are incremented. As noted above, in the preferred embodiments, for any given segment, each data position in an input string corresponds to a single data position in the output string. Accordingly, each pointer preferably is simply incremented to the very next data position (e.g., the next bit position for binary data values). For example, referring again to FIG. 4, assuming that the process 40 is still in the first pass, then in this step 48 the pointers for input strings 11-14 are incremented from data positions 83-86 to data positions 91-94, respectively; at this point, all the data values for calculation of the next output data value 96 are designated.

In step 49, a determination is made as to whether the last output data value for the current segment in the output string 80 has been generated. If not, then processing returns to step 45 to generate the next value. If so, processing proceeds to step 51.

In step 51, a determination is made as to whether the last regular segment of the output string 80 has been processed. For purposes of making this determination, one embodiment uses as a criterion the fraction of the input strings that have a remaining length that is at least as great as the length of the next regular segment (which, as noted above, preferably is fixed across all regular segments). More preferably, the length criterion is incorporated indirectly by requiring a specified fraction of the input strings to be included within the subset selected in step 43 (for the current iteration, or to be selected in the next iteration), and by using the length criterion as one of the criteria for inclusion within such subset.

If it is determined that the last regular segment has been processed, then processing proceeds to step 52. If not, processing returns to step 42, in which the pointer designations are adjusted, and then the next regular segment is processed.

With respect to these subsequent pointer designations, after the first iteration has been completed an entire segment of output string values has been generated using a corresponding segment in each of the input strings. But for the possibility of data value insertions and/or deletions, it typically would be possible to simply maintain the pointers for all of the input strings at the data positions selected during the last execution of step 48. However, the present invention accommodates such insertions and/or deletions in the preferred embodiments by reevaluating alignment of the input strings to the output string 80 (or at least the portion of output string 80 that has been generated to that point) is at the end of defined segments.

For example, FIG. 5 illustrates certain possibilities according to certain embodiments of the invention. In FIG. 5, a segment 100 has just been generated for the output string 80 using the segments 101-104 of input strings 11-14, respectively. It is noted that the various strings 80 and 11-14 are shown in FIG. 5 as being aligned with respect to their corresponding segments 100-104, respectively. However, such segments ordinarily will not occur at the same absolute positions within their respective strings after the second iteration (due to the effects of insertions and deletions).

If the segment of the output string that has just been generated matches the corresponding segment of an input string (e.g., using any of the matching criteria described above), then the pointer for that input string preferably is simply maintained at the data position selected for it during the last execution of step 48. Thus, it is assumed that segment 101 matches segment 100, so that the pointer for string 11 designates the very next data position 111 following the end of segment 101.

On the other hand, if the segment of the output string that has just been generated does not match the corresponding segment of an input string, then it is assumed that at least one insertion or deletion occurred within the segment of the input string; accordingly, a search preferably is performed to find a segment that does match the newly generated segment of the output string 80 (unless such a search is unlikely to identify any such match, e.g., because it is suspected that an insertion or deletion occurred within the present segment of the input string). If such a match is found, then the pointer preferably designates the next data position immediately following the matching segment.

Referring again to FIG. 5, segment 102 (which was used in generating segment 100 in the output string 80) of input string 12 is found not to have matched segment 100. Accordingly, a search is conducted preferably by shifting segment 102 to the left and to the right (within a specified search window) to determine if a match can be found. In the present case, shifting segment 102 one position to the right results in a match (indicating that there was an aggregate of a one-data-position insertion at some point prior to the current segment 102), so the pointer for input string 12 is set to designate data position 112.

Similarly, segment 103 (which also was used in generating segment 100 in the output string 80) of input string 12 is found not to have matched segment 100. However, shifting segment 103 two positions to the left results in a match (indicating that there was an aggregate of a two-data-position deletion at some point prior to the current segment 103), so the pointer for input string 13 is set to designate data position 113.

Still further, if the segment of the output string that has just been generated does not match the corresponding segment of an input string and the search does not result in a match (or a search was not performed because it was deemed unlikely to result in a match), e.g., because it is suspected that an insertion or deletion occurred in the present segment of the input string, then the pointer for that input string preferably is simply maintained at the data position selected for it during the last execution of step 48. Thus, referring again to FIG. 5, segment 104 of input string 14 is found not to have matched segment 100 of output string 80 and no match could be found by shifting segment 104 within a specified search window. Accordingly, the pointer for string 14 designates the very next data position 114 following the end of segment 104.

Returning to FIG. 3, in step 52 (executed after generation of the last regular segment of output data string 80), the final segment of output string 80 is generated. First, the length of the final segment preferably is estimated, e.g., by using the most common remaining length across the input strings. Then, preferably only those input strings having the identified length are used to determine the values for the final segment of output string 80, e.g., in the same manner used to determine the output values for the regular segments of the output string 80. Once again, assuming binary values, the output values for the final segment preferably are determined as the bitwise majority for the corresponding data positions among such input strings.

Finally, in step 54 the output string 80 is output, stored (e.g., onto a computer-readable medium) and/or any additional processing is performed (e.g., by using output string 80 as the basis string 25 for differential compression/decompression, as shown in FIG. 2). As noted above, such additional processing can include, e.g., differentially compressing each of the input strings relative to the output string 80.

FIG. 6 is a flow diagram of a process 140 for generating a representative data string according to a second embodiment of the present invention. As with process 40, discussed above, the steps of the process 140 preferably are performed in a fully automated manner so that the entire process 140 can be performed by executing computer-executable process steps from a computer-readable medium, or in any of the other ways described herein.

The following discussion of FIG. 6 also references algorithm 170, shown in FIG. 7. In this regard, algorithm 170 is one specific implementation of the general process 140. In algorithm 170, all of the data positions in the input strings j (jε{1, 2, . . . , m}) contain binary values.

Referring initially to FIG. 6, in step 141 certain variables are initialized. Preferably, these variables include the segment count i, pointers P(j) to data positions in the input strings j and a selected subset [symbol] As in the previous embodiment, the pointers P(j) preferably are initialized to the very first position in each corresponding input string j, and the selected subset [symbol] to be used for the very first iteration (i.e., generation of data values for the first segment of the output string 80) preferably includes all of the available input strings. Steps 1-3 (designated by reference number 171) of algorithm 170 perform such initializations.

In step 142 output data values are determined for the current segment using the corresponding segments of data values in each of the input strings within subset [symbol] Once again, the preferred technique where the data values are binary is to use the bitwise majority among the corresponding data positions within subset [symbol] as shown in step 4(a) (designated by reference number 172) of algorithm 170. However, any other combination of the corresponding data values from the input strings within subset [symbol] instead may be used, particularly where the values are non-binary.

Next, in step 143 the selected subset of input strings for the current iteration [symbol] is cleared (i.e., set to the empty set). See, e.g., step 4(b) (designated by reference number 173) of algorithm 170.

In step 145, input strings are added to subset [symbol] if specified inclusion criteria are satisfied. In the specific embodiment represented by algorithm 170, such inclusion criteria include: (1) the segment within the input string that was used in generating the newly generated segment for the output string 80 (i.e., in the most recent execution of step 142) matches the newly generated segment for the output string 80, or another matching segment can be found according to specified search criteria, and (2) the remaining length of the input string is at least as great as the next segment to be generated for the output string 80. Once again, the “matching” criterion preferably uses a maximum distance threshold and, more preferably for binary values, uses a maximum Hamming distance threshold δ (in which case a match is referred to as a δ-semi-match). In algorithm 170, this step 145 is performed by the conditional instructions 175 and 180.

In step 146, the pointers P(j) are set for determining the next segment of the output string 80. In the preferred embodiments, this step 146 involves determining whether a matching segment (e.g., a δ-semi-match) exists within a specified search window and, if so, setting the pointer to the data position immediately following the end of the matching segment or, if no match is found, merely advancing the pointer by the length of the current segment (in the present example, a fixed length of l).

The effect of the foregoing rules in the present embodiment is to distinguish between input strings that are within subset [symbol] and those that are not. If a particular input string is included within subset [symbol] then either the present segment matches the newly generated segment of the output string 80 or it does not. If the present segment matches, the above rules dictate setting the pointer at the end of the matching segment, which in the present example is of fixed length l, i.e., advancing the pointer by l data positions. If the present segment does not match, lack of a match is assumed to mean that one or more data positions were inserted into or deleted from the current segment of the input string, meaning that no match is likely to be found within the designated search window, so again the above rules dictate advancing the pointer by l data positions. Both situations therefore are handled by step 176 in algorithm 170. It is noted that for similar reasons, if the present segment does not match, the input string is simply excluded from [symbol] (i.e., it is not added to [symbol] in line 175 of algorithm 170) without performing a search.

On the other hand, if a subject input string is not within subset [symbol] then a search is conducted for different offsets within a search window around the current pointer location in an attempt to identify a segment that matches the newly generated segment of the output string 80. In the present example, the search window is symmetric, being defined by a maximum of Δl shifts to the left and Δl shifts to the right. However, in other embodiments the search window is asymmetric.

In algorithm 170, the search is conducted at lines 178. Then, if a match is found, the pointer is set to the position immediately after the match in line 179, and the input string is added to the selected subset [symbol] in line 180, provided the length criterion is satisfied. Otherwise, if no match is found during the search, then the corresponding pointer is simply advanced l data positions in line 182.

Returning to FIG. 6, in step 148 a determination is made as to whether the last regular segment has been generated for the output string 80. In the present example, the criterion 185 for making this determination in algorithm 170 is that at least three quarters of the input strings must be within subset [symbol] otherwise, it is assumed that the remaining segment of output string 80 is shorter than the required length for a regular segment (e.g., l in this example). However, it should be noted that any other fraction, or any other criterion for that matter, instead can be used in alternate embodiments of the invention. In any event, if it appears that another regular segment can be generated, then processing returns to step 142 to generate that segment (e.g., in the manner described above). Otherwise, processing proceeds to step 149.

In step 149, the data values for the final segment of output string 80 are generated. Preferably, this step first selects the most commonly occurring remaining length, among all of the input strings, as the length l′ of the final segment. Then, the individual data values are determined from the corresponding data positions taken from only those input strings whose remaining length is equal to l′. More preferably, for the present example in which binary values are used, the output data positions are generated as the bitwise majority of the corresponding input string data position values. Steps 5-7 (designated by reference number 187) implement this step 149 in algorithm 170. Upon completion of this step 149, the entire generated output string 80 preferably is output, stored (e.g., onto a computer-readable medium) and/or any additional processing is performed (e.g., by using output string 80 as the basis string 25 for differential compression/decompression, as shown in FIG. 2).

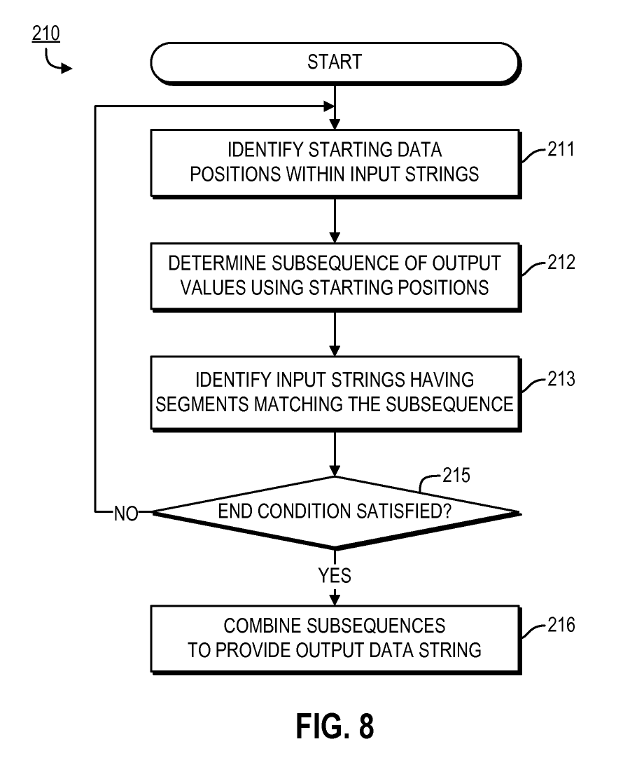

FIG. 8 is a flow diagram of a process 210 for generating a representative data string according to a third embodiment of the present invention. The steps of the process 210 preferably are performed in a fully automated manner so that the entire process 210 can be performed by executing computer-executable process steps from a computer-readable medium, or in any of the other ways described herein.

Initially, in step 211 starting data positions are identified within input strings of data values. Any of the techniques described above in connection with the discussion of step 42 for identifying such starting data positions, e.g., can be used to identify if the starting data positions in this step 211.

Next, in step 212 a subsequence of output data values is determined using the starting data positions identified in step 211. As with the embodiments discussed above, in certain embodiments some of the input strings are given no weight in determining the present subsequence. Preferably, the excluded input strings, if any, are those input strings whose starting data positions are determined to have insufficient reliability in terms of alignment with the starting data position for the output subsequence of data values to be generated. As with the above embodiments, this determination preferably is made based on whether or not a segment within a given input string can be matched to the last subsequence of data values generated for the output string, based on a localized search (e.g., using a range of segment offsets).

For binary values, the present embodiments preferably determine the output data values as the bitwise majority of corresponding data value positions in at least some of the input strings. Where the alphabet of potential data values is larger than binary, the output values preferably are determined as the mean, median or mode of the corresponding data positions within such input strings. Typically, only one data position is used within each of such input strings to determine the value for a corresponding data position in the output string 80, and those data positions will match consecutively, in lockstep.

However, depending upon the embodiment, either or both of these approaches can be modified. For example, if other information (e.g., an error detection code) indicates that a particular data position has been inserted within an input string, then the inserted data position preferably is simply skipped. Similarly, if other information indicates that a particular data position has been deleted, the input string is skipped in determining the value for an output data position where the corresponding data position in the input string has been deleted. Still further, if generation of the input strings is expected to have involved, e.g., redundancy encoding, then data values from multiple data positions within a single input string preferably are used to reconstruct the corresponding data position within the output string 80.

In step 213, input strings having segments that match the subsequence determined in step 212 are identified. Once again, this step preferably first checks the segment of the input string that was used in determining the subsequence and then checks the offsets within a designated search window, unless such a search is expected to be fruitless. Ordinarily, where the insertions and deletions are expected to occur on a random and independent basis, a window around a progressively advancing pointer is preferred. However, in other situations, as discussed in more detail below, additional processing can be used to identify a matching segment.

In step 215, a determination is made as to whether a specified end condition has occurred. For example, the end condition can be based on an indication that the final regular subsequence has been generated (e.g., in view of the remaining lengths of some portion of the input strings) and that the final subsequence, if any, also has been generated. In any event, if the specified end condition has not been satisfied, then processing returns to step 211 in order to generate the next subsequence. If it has, then processing proceeds to step 216.

In step 216, the generated subsequences are combined into a representative output string 80. Once again, that output string 80 can be simply output for subsequent analysis and/or may be further processed, e.g., to differentially compress the input strings 11-14.

Most of the embodiments discussed above generate an output string 80 in units of segments or subsequences. The lengths of such segments or subsequences preferably are determined based on expected probabilities of insertion and deletion, e.g., so that a relatively small fraction (such as less than 5-20%) of the corresponding segments in the input strings will be expected to have been subject to an insertion or deletion. Often, however, such probabilities will not be known in advance, so the segment length(s) are determined dynamically in certain embodiments of the invention (e.g., making the segment length shorter if too few of the input strings are exhibiting matching segments). For embodiments in which the data values are binary, both the segment length l and the search window Δl preferably are expressed as a constant times log n, where n is the expected length of the output string 80.

Several embodiments of the invention have been discussed above. Such embodiments should be understood as merely exemplary and a number of variations are possible.

For example, in most of the above embodiments subsets of the input strings are used in determining data values for the different segments of the output string 80, after which matching segments in the input strings are identified. In alternate embodiments of the invention, segments in the input strings that were used to generate a segment in the output string but are subsequently found not to match the output string are omitted and the remaining input strings are used to regenerate the segment of the output string 80. However, in most cases the additional benefit that can be achieved by such an approach generally will not justify the additional computations.

Most of the embodiments discussed above also utilize a matching criterion for synchronizing individual input strings to the generated output string (typically, the most recently portion of the generated output string). Generally speaking, such matching criteria compare an entire segment of an input string to an entire segment of the output string in order to determine whether they match sufficiently. However, in alternate embodiments finer-grain processing is performed, e.g., to determine where the two sequences fall out alignment. Such approaches often will be particularly useful where the probabilities of insertions, deletions and modifications are relatively low. In such cases, a sub-segment of relatively closely matching data values followed by a sub-segment of highly mismatched data values might indicate that a data value has been inserted or deleted near the point of change, particularly where adjacent data values are relatively uncorrelated with each other.

The embodiments discussed above generally contemplate random and independent data-value additions, deletions and modifications. However, the present invention is applicable beyond such contexts. For example, the present invention can be advantageously applied where multiple versions of a text document exist, with the different versions constituting the input strings. In such embodiments, insertions, deletions and modifications often will be performed in blocks (sometimes fairly large blocks), and chunks of data positions may even be moved from one location to another (which can be represented by a set of deletions and a corresponding set of insertions, although such a representation often will not fully capture the essence of the change). In any event, simply advancing a pointer a fixed distance based on the length of the output segment being generated and searching within a window around that location often will be insufficient to realign an input string with the portion of the output string 80 to which it corresponds.

In such cases, additional processing often will be preferred to assist in performing such realignment. For example, in certain alternate embodiments the input strings are pre-processed (e.g., using chunking, together with min-hash, max-hash and/or approximate hash techniques) to generate a set of location values. Then, if a match to the current output segment is not found in a particular input string (e.g., using the search-window techniques described above), the data values for the generated segment of the output string 80 can be used to locate probable locations (or approximate locations) within the corresponding input string that might match such segment (e.g., by calculating a hash or other digest of the segment of the output string 80 and using the resulting value to access an index of similar values for the subject input string).

As will be readily appreciated, many of the techniques of the present invention identify locations or approximate locations at which insertions, deletions and/or modifications appear to have occurred within an input string. In certain embodiments of the invention, any or all of such information is annotated into the corresponding input string (e.g., as metadata) for future use.

### System Environment.

Generally speaking, except where clearly indicated otherwise, all of the systems, methods and techniques described herein can be practiced with the use of one or more programmable general-purpose computing devices. Such devices typically will include, for example, at least some of the following components interconnected with each other, e.g., via a common bus: one or more central processing units (CPUs); read-only memory (ROM); random access memory (RAM); input/output software and circuitry for interfacing with other devices (e.g., using a hardwired connection, such as a serial port, a parallel port, a USB connection or a firewire connection, or using a wireless protocol, such as Bluetooth or a 802.11 protocol); software and circuitry for connecting to one or more networks, e.g., using a hardwired connection such as an Ethernet card or a wireless protocol, such as code division multiple access (CDMA), global system for mobile communications (GSM), Bluetooth, a 802.11 protocol, or any other cellular-based or non-cellular-based system, which networks, in turn, in many embodiments of the invention, connect to the Internet or to any other networks; a display (such as a cathode ray tube display, a liquid crystal display, an organic light-emitting display, a polymeric light-emitting display or any other thin-film display); other output devices (such as one or more speakers, a headphone set and a printer); one or more input devices (such as a mouse, touchpad, tablet, touch-sensitive display or other pointing device, a keyboard, a keypad, a microphone and a scanner); a mass storage unit (such as a hard disk drive); a real-time clock; a removable storage read/write device (such as for reading from and writing to RAM, a magnetic disk, a magnetic tape, an opto-magnetic disk, an optical disk, or the like); and a modem (e.g., for sending faxes or for connecting to the Internet or to any other computer network via a dial-up connection). In operation, the process steps to implement the above methods and functionality, to the extent performed by such a general-purpose computer, typically initially are stored in mass storage (e.g., the hard disk), are downloaded into RAM and then are executed by the CPU out of RAM. However, in some cases the process steps initially are stored in RAM or ROM.

Suitable devices for use in implementing the present invention may be obtained from various vendors. In the various embodiments, different types of devices are used depending upon the size and complexity of the tasks. Suitable devices include mainframe computers, multiprocessor computers, workstations, personal computers, and even smaller computers such as PDAs, wireless telephones or any other appliance or device, whether stand-alone, hard-wired into a network or wirelessly connected to a network.

In addition, although general-purpose programmable devices have been described above, in alternate embodiments one or more special-purpose processors or computers instead (or in addition) are used. In general, it should be noted that, except as expressly noted otherwise, any of the functionality described above can be implemented in software, hardware, firmware or any combination of these, with the particular implementation being selected based on known engineering tradeoffs. More specifically, where the functionality described above is implemented in a fixed, predetermined or logical manner, it can be accomplished through programming (e.g., software or firmware), an appropriate arrangement of logic components (hardware) or any combination of the two, as will be readily appreciated by those skilled in the art.

It should be understood that the present invention also relates to machine-readable media on which are stored program instructions for performing the methods and functionality of this invention. Such media include, by way of example, magnetic disks, magnetic tape, optically readable media such as CD ROMs and DVD ROMs, or semiconductor memory such as PCMCIA cards, various types of memory cards, USB memory devices, etc. In each case, the medium may take the form of a portable item such as a miniature disk drive or a small disk, diskette, cassette, cartridge, card, stick etc., or it may take the form of a relatively larger or immobile item such as a hard disk drive, ROM or RAM provided in a computer or other device.

The foregoing description primarily emphasizes electronic computers and devices. However, it should be understood that any other computing or other type of device instead may be used, such as a device utilizing any combination of electronic, optical, biological and chemical processing.

### Additional Considerations.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

What is claimed is:

1. A method of generating a representative data string, comprising:
(a) identifying starting data positions within input strings of data values;
(b) determining a subsequence of output data values based on the data values at data positions determined with reference to the starting data positions within the input strings;
(c) identifying which of the input strings have segments that match the subsequence of output data values, based on a matching criterion;
(d) repeating steps (a)-(c) for a plurality of iterations; and
(e) combining the subsequences of output data values across said iterations to provide an output data string,
wherein the determination in step (b) for a current iteration is based on the identification in step (c) for a previous iteration.

2. A method according to claim 1, wherein the output data values are determined on a bit-by-bit basis.

3. A method according to claim 1, wherein for a given input string for which a match was identified in the current iteration of step (c), the starting data position for a next iteration is set immediately after the segment resulting in the match.

4. A method according to claim 1, wherein for a given input string for which no match was identified in the current iteration of step (c), the starting data position for a next iteration is advanced a length of the subsequence of output data values for the current iteration.

5. A method according to claim 1, wherein within the current iteration, each output data value in the subsequence is determined based on the single data position relative to the starting data position within each of a plurality of the input strings.

6. A method according to claim 5, wherein each output data value in the subsequence is determined as a bitwise majority of the data values in said single data positions across said plurality of the input strings.

7. A method according to claim 1, wherein in order for a given input string to be considered in the determination of step (b) in the current iteration, a match must have been identified for the given input string in step (c) of an immediately previous iteration.

8. A method according to claim 1, wherein a length of the subsequence of output data values is constant across substantially all of the iterations.

9. A method according to claim 1, further comprising a step of compressing the input strings relative to the output data string.

10. A method according to claim 1, further comprising a step of using at least one of a chunking-based technique and a digest-based technique to realign a plurality of the input strings to a current point in the output data string.

11. A method according to claim 1, wherein the matching criterion comprises evaluation of segments within a limited search window that is positioned based on an estimated matching location.

12. A method of generating a representative data string, comprising:
(a) setting a pointer to a data position within each of a plurality of input strings of data values;
(b) selecting a subset of the input strings;
(c) generating an output data value based on the data values designated by the pointers within the subset of the input strings;
(d) appending the output data value to an output data string;
(e) incrementing the pointers within the subset of the input strings;
(f) repeating steps (c)-(e) a plurality of times so as to generate a new segment of the output data string; and
(g) repeating steps (a)-(f) for a plurality of iterations,
wherein the pointers are set in a current iteration of step (a) based on an ability to match portions of the input strings to the new segment of the output data string generated in an immediately previous iteration.

13. A method according to claim 12, wherein a criterion for a given input string to be included within the subset selected in step (b) of the current iteration comprises identification of a match between a segment of the given input string used to generate the new segment in the immediately previous iteration and the new segment generated in the immediately previous iteration.

14. A method according to claim 12, wherein each of the pointers is incremented in step (e) by a single data position.

15. A method according to claim 12, wherein if a given input string was included in the subset for the immediately previous iteration, the pointer is set in step (a) of the current iteration to the data position selected in step (e) of the immediately previous iteration.

16. A method according to claim 12, wherein if a given input string was not included in the subset for an immediately previous iteration, a search is conducted within a specified search window in an attempt to identify a segment within the given input string matching the new segment of the output data string, and the pointer is set in step (a) of the current iteration based on results of the search.

17. A method according to claim 12, wherein matches are determined based on corresponding Hamming distances between the portions of the input strings to the new segment of the output data string generated in the immediately previous iteration.

18. A method according to claim 12, wherein each output data value is determined as a bitwise majority of the data values designated by the pointers within the subset of the input strings.

19. A method according to claim 12, wherein each output data value generated in step (c) is a single bit.

20. A computer-readable medium storing computer-executable process steps for generating a representative data string, said process steps comprising:
(a) identifying starting data positions within input strings of data values;
(b) determining a subsequence of output data values based on the data values at data positions determined with reference to the starting data positions within the input strings;
(c) identifying which of the input strings have segments that match the subsequence of output data values, based on a matching criterion;
(d) repeating steps (a)-(c) for a plurality of iterations; and
(e) combining the subsequences of output data values across said iterations to provide an output data string,
wherein the determination in step (b) for a current iteration is based on the identification in step (c) for a previous iteration.
